(19) United States
(12) Patent Application Publication
(10) Pub. No.: US 2017/0235158 A1
(43) Pub. Date: Aug. 17, 2017

(54) ELECTRONIC MEDICAL DEVICES AND METHODS

(71) Applicant: EP GLOBAL COMMUNICATIONS, INC., Irvine, CA (US)

(72) Inventors: David T. Markus, Irvine, CA (US); Michael C. Hayes, Irvine, CA (US); Arthur Back, Pleasanton, CA (US)

(73) Assignee: EP Global Communications, Inc., Irvine, CA (US)

(21) Appl. No.: 15/502,201

(22) PCT Filed: Aug. 5, 2015
(86) PCT No.: PCT/US2015/043783

§ 371 Date: Feb. 6, 2017

Related U.S. Application Data
(60) Provisional application No. 62/033,355, filed on Aug. 5, 2014.

(51) Int. Cl. G02C 7/08; B29D 11/00; G02C 11/00; G02C 7/04; G02C 7/10

(52) U.S. Cl. CPC G02C 7/083; G02C 7/049; G02C 7/101; G02C 11/10; B29D 11/00038; B29D 11/0048; B29K 2995/0018

(57) ABSTRACT

The present disclosure provides an elastic electronic circuit adapted to provide three dimensional elasticity while conforming to the curved or angled structures of a swellable medical device, such as a hydrogel or silicone hydrogel contact lens. The elastic electronic circuit can include a first pattern for flexibility in a first dimension, a second pattern for flexibility in a second dimension, and a third pattern for flexibility in a third dimension. Alternatively, the elastic circuit can include a first pattern for flexibility in a first dimension and a second pattern for flexibility in a second dimension. The resulting three-dimensional elasticity enables the use of electronic circuits on soft contact lenses, where manufacture and use will cause the lenses and circuits to swell and shrink. Furthermore, the electronic circuit will not distort the vision correction of the contact lens or otherwise cause discomfort or other negative side effects.

### CROSS-REFERENCE TO RELATED APPLICATIONS

This application claims the benefit of PCT/US15/43783, filed on Aug. 5, 2015, which claims the benefit of U.S. Provisional Patent Application No 62/033,355, filed on Aug. 5, 2014, both of which are incorporated herein by reference.

### STATEMENT REGARDING FEDERALLY SPONSORED RESEARCH AND DEVELOPMENT

Not Applicable.

### FIELD OF THE INVENTION

This invention relates generally to an electronic circuit, and more particularly, to an elastic electronic circuit embedded on or within a medical device, such as a swellable or flexible contact lens, which can swell, stretch and contract in multiple dimensions.

### DISCUSSION OF RELATED ART

There are two common types of contact lenses, hard lenses and soft lenses. Hard lenses, also known as rigid gas permeable lenses (RGP lenses), are rigid contact lenses made from hard plastic or glass. Hard lenses are frequently uncomfortable for most users due to their lack of flexibility.

Soft lenses are often preferred over hard lenses due to their increased comfort. Soft lenses are typically made from hydrogel materials or silicone hydrogel materials. Both hydrogel contact lenses and silicone hydrogel contact lenses are flexible and can expand and contract as they absorb or lose fluid, such as water, during use or during their manufacture

Stretchable electronics can generally be described as electronic circuits adapted to stretch in one or two dimensions. Stretchable electronics are generally embedded on a stretchable medium and are adapted to stretch only within one or two dimensions with the medium without losing electrical connectivity between electronic components. However, stretchable electronics have not been successfully adapted to swellable medical devices, including contact lenses. In particular, stretchable electronics have not been incorporated into hydrogel materials employed in the manufacture of medical devices, including contact lenses. Furthermore, there is currently no stretchable electronic circuit adapted to provide elasticity within or on a curved profile of a contact lens.

Accordingly, there is a continued need for an elastic circuit adapted to stretch in multiple dimensions on or in a swellable medical device. The present disclosure satisfies these and other needs.

### SUMMARY OF THE INVENTION

Briefly, and in general terms, the present disclosure is directed towards an elastic electronic circuit adapted to provide multi-dimensional elasticity while conforming to curved structures of a swellable medical device, such as an ophthalmic lens, which includes contact lenses. In one particular aspect, the elasticity of the electronic circuit is configured such that the operation of the swellable medical device remains predictable and consistent. In another particular aspect of ophthalmic lenses, the electronics contained in the ophthalmic lens does not cause undesired distortion or deformation should the lens flex, stretch, swell or otherwise change size or shape.

In further aspects, the electronic circuit of a swellable contact lens enhances, modifies or extends lens function and in particular, can operate to achieve one or more of providing diagnostics or changing refractive power, focal length, light intensity, transmission control and zoom capabilities of a lens. Various lens effects are thus contemplated including controlled volume displacement, deformation, surface curvature change, thickness changes and modification of dioptric power. In order to accomplish such effects, one or more of mechanical deformation, squeezing, perimeter changes and circumferential or diametric changes can be employed. Moreover, various actuators such as electromagnetic energy, piezoelectric effects, shape memory materials or motors can be utilized.

In one approach, an elastic electronic circuit includes electronic components connected by interconnections that have discrete curved or angled structures formed therein. Such structures can define a repeating or non-repeating pattern of curves or angle portions that provide the electronic circuit with desired elasticity appropriate for the swellable medical device. In a second approach, the electronic interconnections can include additional curved or angled portions embedded within a first pattern of repeating or non-repeating curves or angles. Again, these embedded curved or angled portions can define repeating or non-repeating patterns and are configured to provide elasticity in multiple dimensions. In yet another approach, the electronic interconnections can include two levels of embedded curved or angled portions provided in repeating or non-repeating patterns. Moreover, the interconnections and electronic components can be formed into various closed or open shapes and the curved or angled portions thereof can be curved or angled to match or adapt to a curvature of the lens or other medical device. In one embodiment, the electronic components and interconnections can form a circle, and one or more of the electronic components and curved or angled portions can have planar, non-planar, curved or folded profiles cooperating with that of the lens.

In one particular embodiment, there is provided a swellable medical device that includes a substrate having a first size, and formed of a material that allows the substrate to swell to a second size that is different than the first size, and an elastic electronic circuit provided on or in the substrate, the elastic electronic circuit including a first pattern that allows the elastic electronic circuit to stretch as the substrate swells from the first size to the second size. In a method of manufacture, there can be provided an approach to a swellable medical device involving forming a material into a substrate having a first size and that can swell to a second size that is different than the first size and providing an elastic electronic circuit on or in the substrate, wherein the elastic electronic circuit comprises a first pattern that allows the elastic electronic circuit to stretch as the substrate swells from the first size to the second size. Moreover, there can be provided a medical device including a substrate that changes size from a first size, to second and third sizes, either by expanding or shrinking, and an elastic electronic circuit provided in the substrate which accommodates such changes in size without distorting the substrate.

Additional embodiments and aspects of electronic circuit will be apparent from the following description, drawings, and claims. As can be appreciated from the foregoing and following description, each and every feature described herein, and each and every combination of two or more of such features, and each and every combination of one or more values defining a range, are included within the scope of the present invention provided that the features included in such a combination are not mutually inconsistent. In addition, any feature or combination of features or any value(s) defining a range may be specifically excluded from any embodiment of the present invention.

### DESCRIPTION OF THE DRAWINGS

Embodiments of this invention may best be understood by referring to the following description and accompanying drawings that are used to illustrate the invention. In the drawings:

FIG. 1A is a simplified cross-sectional view of a mold useful for forming a swellable contact lens, as an example of a swellable medical device;

FIG. 1B is a cross-sectional view of the mold of FIG. 1 having a polymerizable composition disposed therein and being located in a tray useful in a system for making a swellable medical device;

FIG. 2 is a diagram illustrating a horseshoe patterned elastic electronic circuit in one dimension;

FIG. 3 is a diagram illustrating an elastic circuit within a swellable contact lens;

FIG. 4 is a diagram illustrating another elastic circuit within a swellable contact lens;

FIG. 5 is a diagram illustrating a horseshoe patterned circuit in two dimensions;

FIGS. 6A-D are enlarged cross-sectional views, depicting patterns which can be incorporated into the circuit of FIG. 5;

FIG. 7A is a diagram illustrating a horseshoe pattern in more than two dimensions:

FIGS. 7B-E are enlarged cross-sectional views, depicting angled patterns that can be incorporated into the circuit of FIG. 7A;

FIGS. 7F-I are enlarged cross-sectional views, depicting curved patterns that can be incorporated into the circuit of FIG. 7A;

FIG. 8A is a diagram illustrating a planar interconnecting member mold;

FIG. 8B is a diagram illustrating a non-planar interconnecting member mold;

FIG. 9A is a diagram illustrating a planar elastic electronic circuit;

FIG. 9B is a diagram illustrating a non-planar elastic electronic circuit;

FIG. 10A is a diagram illustrating a folded elastic electronic circuit;

FIG. 10B is a diagram illustrating an unfolded elastic electronic circuit;

FIG. 11 is a diagram illustrating a folded structure of an elastic electronic circuit in a contact lens; and

FIG. 12 is an illustration of a lens precursor dispensing apparatus.

### DETAILED DESCRIPTION OF THE PREFERRED EMBODIMENT

Embodiments of the present disclosure are described herein in the context of an electronic circuit embedded within a contact lens adapted to swell, stretch and contract within three dimensions. Although the present disclosure is exemplified in the context of a swellable medical device, it will be understood that the present disclosure relates to medical devices that can stretch and contract within three dimensions. Some embodiments include swellable ophthalmic devices, which include swellable contact lenses (e.g., hydrogel contact lenses and silicone hydrogel contact lenses), swellable corneal onlay lenses, swellable ophthalmic implants, which may be implanted in the conjunctival fornix, within the stroma of the eye, or within the anterior chamber or posterior chamber of the eye, and swellable intraocular lenses, or medical devices including diagnostic or sensing systems.

Those of ordinary skill in the art will realize that the following detailed description of the present disclosure is illustrative only and is not intended to be in any way limiting. Other embodiments of the present invention will readily suggest themselves to such skilled persons having the benefit of this disclosure. Reference will now be made in detail to implementations of the present disclosure as illustrated in the accompanying drawings. The same reference indicators will be used throughout the drawings and the following detailed description to refer to the same or like parts.

The present disclosure is directed towards an elastic electronic circuit adapted to provide three-dimensional elasticity while conforming to the curved or angled structure of a swellable medical device such as a swellable contact lens, or otherwise adapted to accommodate stretching and flexure resulting from handling including insertion, placement and removal. As used herein, swellable refers to the ability of a medical device, such as a contact lens, to absorb a liquid and increase in size by at least 5%. Swelling can occur at one or more stages during manufacture or processing of the medical device. The change in size can be a change in thickness, length, width, diameter, sagittal depth, or curvature, or changes can be regular or irregular, upon hydration or dehydration, or from folding, and the like, during manufacture or use including insertion and removal. A swellable device can be contacted with a liquid and increase in size to become a swollen device. The swollen device can be contacted with a different liquid or allowed to lose liquid to decrease in size to become a partially swollen device or dehydrated swellable device. The liquid used to swell the swellable medical device can be an aqueous liquid, such as water, buffered saline solutions (e.g., packaging solutions or cleaning solutions), or can include one or more organic solvents, which may also be mixed with water.

The components of the elastic electronic circuit are adapted to embed into or integrate within swellable and stretchable polymers, including contact lenses, and are further adapted to provide electrical connection on or within a contact lens. Moreover, it is contemplated that a contact lens embodying the disclosed electronic circuit is shaped for comfort and fit and is formed from biocompatible materials. Further, the electronics are adapted such that they will not undesirably distort the vision correction, or prescription, of the contact lens, or shape for comfort or fit.

The term “contact lens” as used herein refers to an ophthalmic lens which is of a structure, size, shape and power that it can be worn on the cornea of an eye. The term “contact lens” can also be understood to refer to an article which upon removal from a mold needs to be treated, for example, hydrated and swelled into a lens of size, shape and power as to be wearable on an eye.

Preferably, the swellable contact lens is a hydrogel contact lens, more preferably a silicone hydrogel contact lens, or otherwise formed from material that changes shape during manufacture or processing. As used herein, a hydrogel contact lens or a silicone hydrogel contact lenses refer to contact lenses that have an equilibrium water content (EWC) of at least 10% wt/wt, as understood by persons or ordinary skill in the art. In certain embodiments, the swellable contact lenses have an EWC from about 15% to about 70%. In further embodiments, the swellable contact lenses have an EWC from about 25% to about 65%. In still further embodiments, the swellable contact lenses have an EWC from about 35% to about 60%.

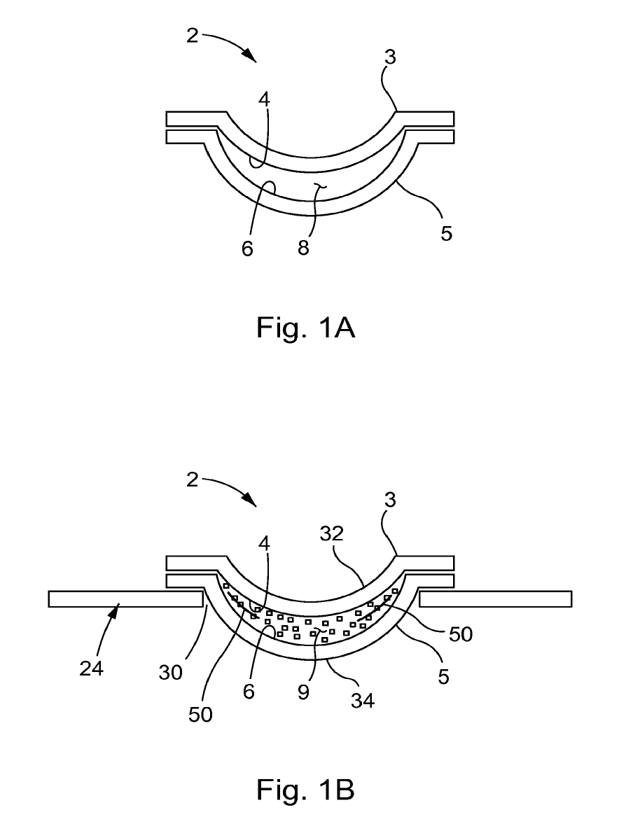

In a broad aspect, methods of manufacturing swellable medical devices, including swellable ophthalmic lenses, for example but not limited to soft silicone hydrogel lenses, are provided. Referring to FIGS. 1A-B, the methods generally include providing a mold assembly 2, such as the mold assembly 2 shown in cross section. The mold assembly 2 may include a first mold section 3 having a first lens defining surface 4 and a second mold section 5 having a second lens defining surface 6. The first and second mold sections 3 and 5 define a lens shaped cavity 8 between the first and second lens defining surfaces 4 and 6 when the first mold section 3 and the second mold section 5 are assembled together.

Turning now to FIG. 1B, a polymerizable composition 9 is provided in the lens shaped cavity 8. The polymerizable composition 9 can be understood to be a lens precursor composition. The polymerizable composition 9 can be a composition including one or more monomeric components suitable for producing contact lenses. The polymerizable composition 9 can be provided in the lens shaped cavity 8 by a number of different methods, for example, by injecting, dispensing, or otherwise introducing a polymerizable composition 9 into the lens shaped cavity.

Ophthalmic lenses manufactured using the present systems and methods may include ophthalmic lenses made from biocompatible materials. Examples of suitable materials include, and are not limited to, hydrogel polymers, silicone hydrogel polymers, acrylic polymers, polyolefins, fluoropolymers, silicones, styrenic polymers, vinyl polymers, polyesters, polyurethanes, polycarbonates, cellulosics, proteins including collagen-based materials and the like and mixtures thereof. Preferably, for the manufacture of contact lenses in accordance with the present disclosure, the polymerizable composition comprises a formulation comprising one or more silicon-containing monomers and/or silicone-containing macromers. Examples of suitable contact lens formulations that may be used in the present invention include formulations having the following United States Adopted Names (USANs): etafilcon A, nelfilcon A, hilafilcon A, methafilcon A, ocufilcon A, ocufilcon B, ocufilcon C, ocufilcon D, omafilcon A, omafilcon B, balafilcon A, lotrafilcon A, lotrafilcon B, delfilcon A, galyfilcon A, senofilcon A, narafilcon A, narafilcon B, comfilcon A, etafilcon A, or stenfilcon A.

To provide an electronic contact lens, the electronic components must be incorporated into the material being employed to manufacture the lens. In order to accomplish this, the manufacturing process of the contact lens is to be appreciated.

The present contact lenses are preferably made by a cast molding manufacturing process. In short, a polymerizable composition, or lens formulation, is placed on a concave mold surface of a female mold half, and a male mold half is placed in contact with the female mold half to such that a convex mold surface contacts the polymerizable composition and a contact lens mold assembly is formed. The polymerizable compositions are polymerized by placing then contact lens mold assemblies in a curing oven, which may use heat or light (e.g., visible or UV light, or combinations thereof) and the like to form polymerized contact lens products. The mold assemblies are separated to expose the polymerized contact lens products on one of the mold halves. Subsequently, the contact lens product is separated from the mold half to which it is attached in a delensing step. The delensed or separated contact lens product is optionally inspected for defects, and then contacted with a liquid. For example, the separated contact lens product may be placed directly in a contact lens package and contacted with a contact lens packaging solution, or the separated contact lens product may be washed to remove residual materials prior to placement in the contact lens package. The washing step can be viewed as an extraction, and it may employ the use of liquids that include aqueous solutions, organic solvents, or combinations thereof. The contact lens package containing the contact lens and the packaging solution are then sealed and sterilized.

In the commercial manufacture of silicone hydrogel contact lenses, one or more washing steps using volatile organic solvents, such as alcohol, can be used to remove unreacted or partially reacted chemicals, especially hydrophobic chemical ingredients, from the polymerized lens bodies prior to packaging. This is frequently referred to as an extraction process to remove extractable material from the polymerized silicone hydrogel contact lens product. The use of volatile organic solvents facilitates removal of a component of the polymerized silicone hydrogel contact lens that has poor solubility in aqueous solutions or water. When an organic solvent, such as alcohol, is used to wash a silicone hydrogel contact lens, the contact lens increases in size or swells. For example, it is not uncommon for a pre-washed silicone hydrogel contact lens to have a first diameter, such as about 14.0 mm, and for the same silicone hydrogel contact lens to have a second diameter that is about twice as large as the first diameter after contacting the organic solvent, such as increasing to about 28.0 mm. It is also necessary to process the swollen lenses so that they return to their initial size, such as about 14.0 mm in diameter, such as by removing the alcohol using water or other aqueous solutions. It can also be appreciated that swellable contact lenses that are not exposed to organic solvents in an extraction step may swell by less than 100%, as suggested above, and they may swell upon the absorption of aqueous solutions. The swelling may result in an increase in size, such as an increase in lens diameter or lens thickness, of at least 10%. Such an increase in size can be relative to the molded size or for example, after polymerization but prior to contact with a liquid. Thus, incorporating electronics into a lens manufactured with this process must take such swelling and retraction into consideration.

Additionally, incorporation of the electronic circuit must take such swelling of the contact lens substrate, whether this occurs during manufacturing or during packaging

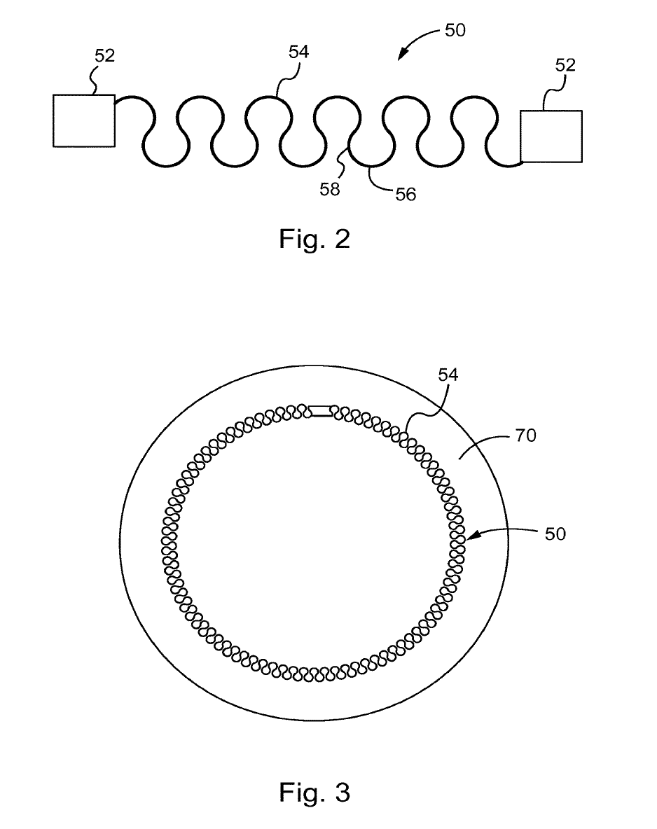

Referring now to FIG. 2, there is shown a first approach to an elastic electronic circuit 50 which can be incorporated into a contact lens 70. Here, spaced electronic components such as integrated circuits, piezoelectric components, resistors, capacitors, LEDs, amplifiers, transistors, sensors, antennas, or other electronic chips, or the like 52 are connected by interconnecting members 54. The electronic components of the electronic circuit can be selected or configured to achieve, alone or in combination, one or more of changing refractive power, focal length, light intensity, transmission control and zoom capabilities of a lens. Various lens effects can include controlled volume displacement, deformation, surface curvature change, thickness changes and modification of dioptric power. Further, the electronic components can operate or cooperate to accomplish one or more of mechanical deformation, squeezing, perimeter changes, circumferential or diametric changes, and chemical or physical sensing can be provided. Moreover, various actuators such as electromagnetic energy, piezoelectric effects, shape memory materials or motors can be utilized to facilitate such action.

The interconnecting members can include curved portions 56, 58 which provide the interconnecting member 54 with desired elasticity in response to an applied pressure or force, stretching, folding, elongation, or to swelling or retracting action of material forming a contact lens, such as that occurring during use or manufacturing. Although shown as including a repeating pattern of curved portions, the interconnecting member 52 can include a single curved portion, a plurality of discrete spaced or continuous curved portions, an irregular pattern of curved or angled portions, or combinations thereof.

Accordingly, as shown, in a first approach to the interconnecting member 54, the elastic circuit is adapted to provide elasticity in at least a first dimension. The repeating pattern of curved portions 56, 58 of the interconnecting member 54 can be attached to a stretchable polymer and further includes a pattern path, pattern width, an overall width, a radius of curvature, and a turning degree offset. In one embodiment, this pattern embodies semicircles which form a generally horseshoe pattern. The turning degree offset can range between 30 and 60 degrees, as each partial circle will not share a center line. The horseshoe shaped interconnects maintain their recurring shape by having different turning degrees at each connection point between adjacent curved portions 56, 58. In one particular approach, the pattern can embody a horseshoe shape having a turning degree from 0 degrees to 45 degrees. Further, the substrate can have a semispheroidal shape having an apex region, and the elastic electronic circuit circumscribes the apex region. In alternative embodiments (not shown), the repeating pattern of horseshoe curved portions can be replaced with one or more of a sine wave, a square wave or a triangle wave, or combinations thereof, in repeating or non-repeating patterns.

Turning now to FIGS. 2 and 3, there is shown the repeating pattern of horseshoe shaped interconnecting member 54 incorporated into a contact lens 70. As shown, the interconnecting member 54 is arranged to define a circle. Such a configuration is generally believed to be well adapted for contact lenses; however, it is contemplated that the interconnecting member 54 can assume various other shapes. For example, rather than a circle, the interconnecting member 54 can be formed into various polygonal or curved shapes and can also define open or closed patterns as may be deemed necessary for a particular application.

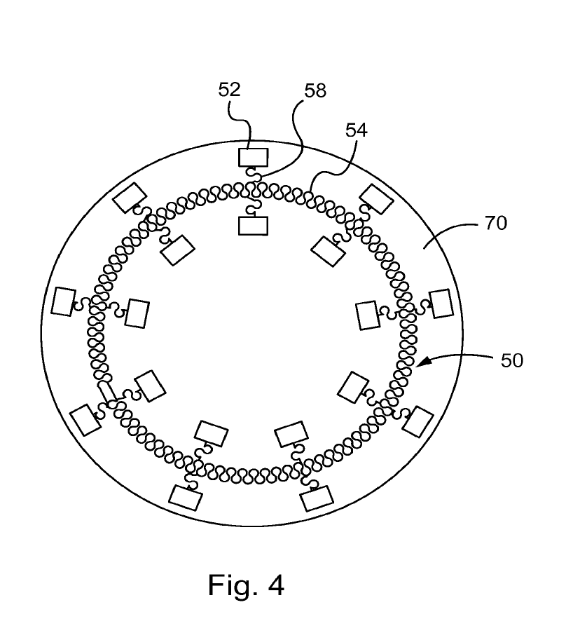

With specific reference to FIG. 4, various electronic components 52 can be attached along the interconnecting member 54 both radially inward and outward of the interconnecting member 54. Moreover, the electronic components 52 can be directly connected to the interconnecting member 54 and thus form a portion of the circle or other pattern defined by the interconnecting member 54, or as shown in FIG. 4, additional substructure in the form of curved arms 58 can be employed to connect the electronic components to the interconnecting members 54. Such arms 58 need not include a regular pattern of curved portions, but can be straight members or have irregular patterns of straight, curved or angled portions, or combinations thereof. Again, although a repeating pattern of electronic components are depicted, fewer or more electronic components can be incorporated into a circuit design in any conceivable pattern.

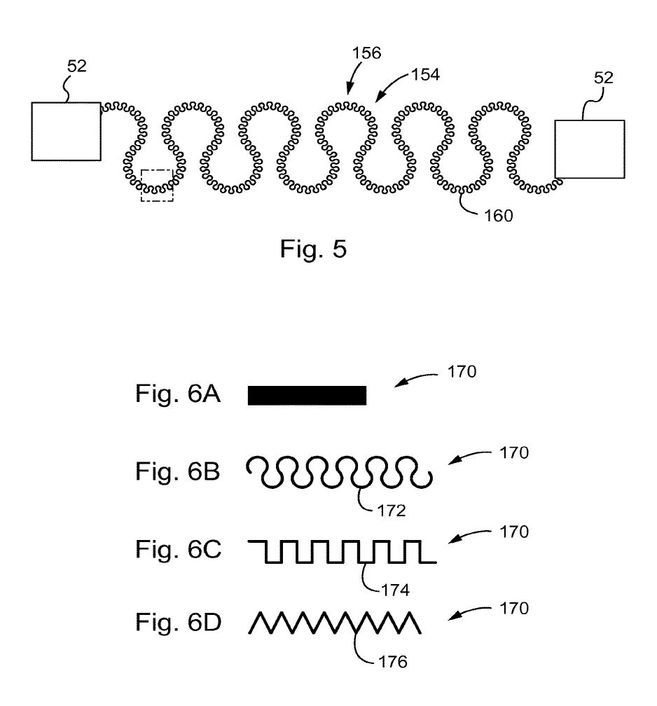

Referring now to FIG. 5, a second approach to interconnecting members for an elastic circuit is presented. Here, the interconnecting member 154 can include a second sub-structural pattern of curved or angled portions embedded within the first pattern 156 and is adapted to provide elasticity in multiple dimensions. As shown, both the first pattern 156 and the second or embedded pattern 160 are defined by horseshoe shaped curved members. The second pattern 160 will follow the path of the first pattern 156, but provides a second pattern 160 within the first pattern 156. In one preferred embodiment, the second pattern 160 is identical to the first pattern 156, albeit smaller in scale. Specifically, the second pattern 160 can embody semicircles which form a generally horseshoe pattern. However, it is to be recognized that as before, the first or primary pattern 156 can be replaced by other discrete or continuous, repeating or non-repeating, curved or angled patterns or structure. This is the same for the embedded or secondary pattern 160, that is, rather than defining a repeating pattern of horseshoe shaped embedded structures 160, the embedded sub-structures can also be defined by discrete or continuous, repeating or non-repeating, curved or angled patters or structure. Thus, in contemplated alternative embodiments, the first 156 or second patterns 160 can assume a sine wave, a square wave, or a triangle wave (not shown).

Further, the interconnecting member 154 can include both a first 160 and a second 170 embedded pattern or sub-structure. This third approach to an elastic circuit can be adapted to provide elasticity in further dimensions. With reference to FIGS. 6A-D, there are shown various cross-sections of the interconnecting member 154. FIG. 6A depicts a cross-section of an interconnecting member 154 that has only a single embedded pattern or sub-structure 160 and consequently defines a straight member. This interconnecting member 154 is generally planar, and has a single height or thickness. FIGS. 6B-D illustrate cross-sections of interconnecting members 154 that include both first 160 and second 170 embedded patterns or sub-structures. While these secondary embedded structures 170 each include portions residing in a single plane, the height or thickness of these approaches to interconnecting members varies along the length of the interconnecting member according to the secondary embedded pattern 170. Here again, although specific patterns of secondary embedded structures 170 are illustrated, other patterns and repeating or non-repeating curved or angled structures, or combinations thereof can be employed. As before, the secondary embedded sub-structure 170 can be applied to the stretchable polymer from which the elastic circuit is attached and further includes a radius of curvature and a turning degree offset. In one preferred embodiment (See FIG. 6B), the secondary embedded pattern 170 embodies semicircles which form a generally horseshoe pattern 172. The turning degree offset can range between 30 and 60 degrees, as each partial circle will not share a center line. The horseshoe shaped interconnects maintain their recurring shape by having different turning degrees at each connection point. In alternative approaches, the secondary embedded structure can assume a square wave 174 (FIG. 6C) or a triangle wave 176 (FIG. 6D). Again, other further secondary embedded structures are contemplated, whether repeating or non-repeating, discrete or continuous.

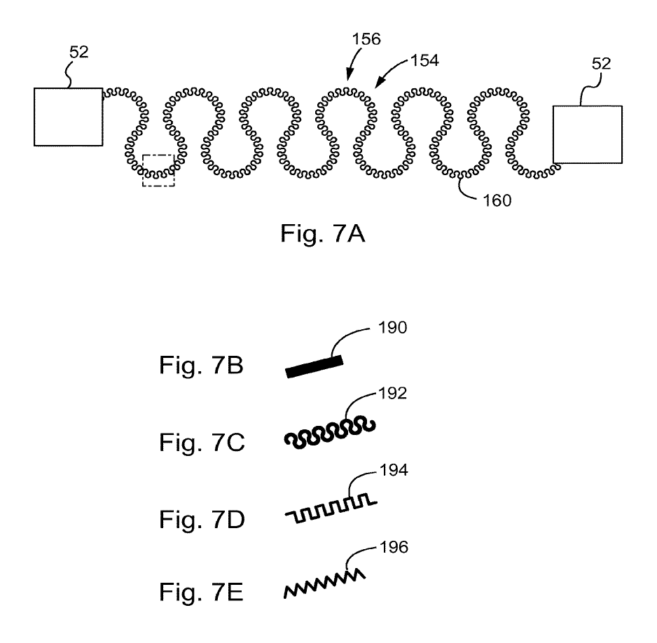

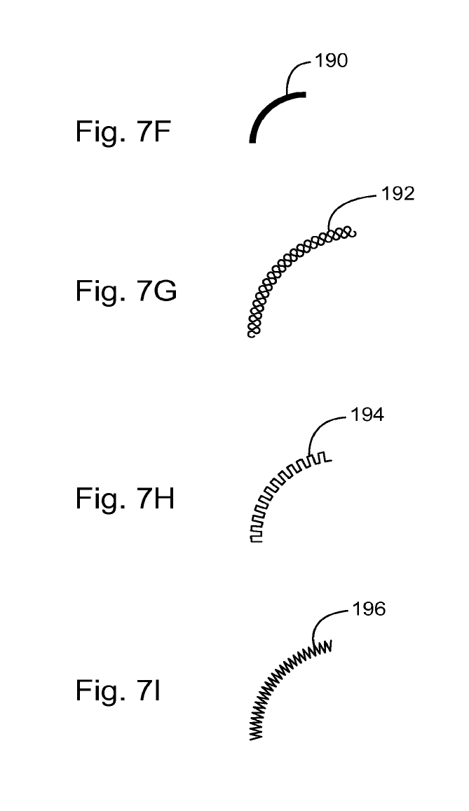

To be accommodated by a swellable medical device such as a hydrogel or silicone hydrogel contact lens, the interconnecting member or members 154 can be further curved or angled so as to define an assembly assuming an overall non-planar structure (See FIGS. 7A-I). That is, whereas the primary 160 and secondary patterns 170 of the interconnecting member 154 presented above each include portions along a length of the interconnecting member 154 which reside in a single plane, an electronic assembly including the interconnecting member or members 154 also can be configured to have curved or angled portions selected pairs or groups of which do not reside in a single plane. That is, as illustrated in FIGS. 7A-I, an electronic circuit can be further adapted to conform to the curved or angled structure of a contact lens, or other medical device. As such, the structure is not adapted to extend linearly, but rather, it can follow a generally curved or angled structure.

With reference to FIGS. 7B-E, a cross-section of the interconnecting member 154 shows that its substructure follows an angled path that diverts from a horizontal plane, whether the substructure is characterized, for example, by a linear 190 (FIG. 7B), horseshoe 192 (FIG. 7C), square wave 194 (FIG. 7D) or triangle wave (FIG. 7E) repeating pattern. As shown in FIGS. 7F-I, the path that the substructure follows can also be curved or non-planar. It is to be further recognized that these paths can have various angles and radii of curvature and can be random or patterned, or a combination of the same. In one particular approach as shown in FIG. 70, a horseshoe pattern 192 on the convex side of the curved structure are generally further apart and the horseshoe patterns on the concave side of the curved structure are generally closer together.

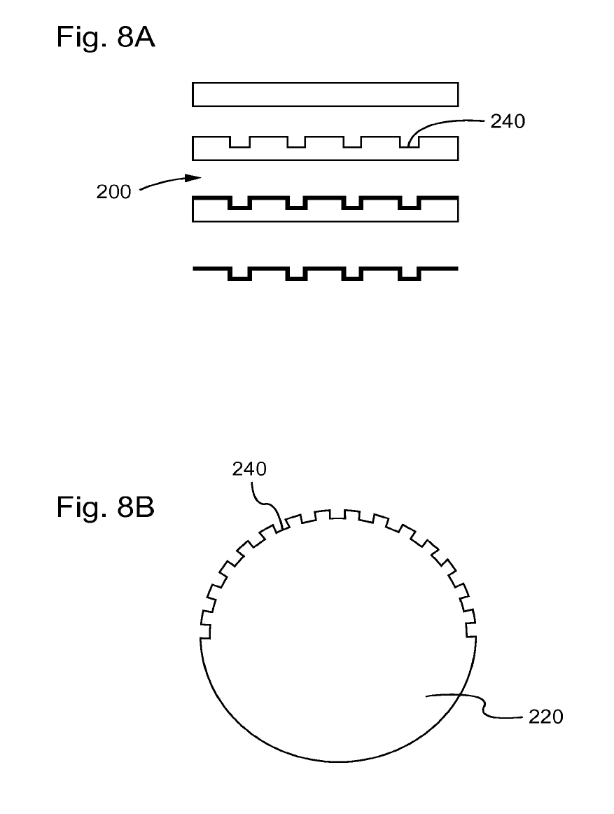

A first step in manufacturing is to create the electronic circuit prior to the creation of the contact lens. In one exemplary approach, an interconnection mold 200, 220 is patterned with grooves 240 according to a desired pattern such as a square wave pattern for planar 200 (FIG. 8A) and non-planar (FIG. 8B) molds, respectively. The desired interconnection member pattern substrate is cast onto the mold 200, 220 by electro spray, spin on coating, or deposited by chemical vapor deposition. The mold is chemically or mechanically removed to obtain the mold pattern 200, 220.

Next, in order to fabricate the desired interconnection member, the negative pattern created on the mold 200, 220 is filled with the substrate material and cured. The mold is then removed to obtain the desired interconnection pattern.

Alternatively, the desired interconnection member can be etched from substrate material. Several methods can be used, including: direct laser etching, chemical etching, photodefinable etching by direct photo patterning, and plasma etching.

For laser etching, the pattern design is entered into a software laser controller program, where a laser head is controlled using gimbals head, xyz axis stages and rotation stages.

No masking material is needed as the laser will etch along the border or perimeter of the pattern. For chemical etching, the pattern is transferred onto the interconnection substrate using photoresist and photolithography. The substrate is soaked into a chemical etchant that can selectively etch the substrate and the photoresist at a different etch rate. The photoresist is rinsed off after the wet etching is complete.

For photodefinable etching by direct photo patterning, the substrate material is photosensitive to UV light and a photomask or direct laser UV pattern is used to create the first and second patterns in a photo developer. For plasma etching, the substrate will have a thin coating of metal film ranging from 0.1 um to 10 um. The first and second patterns are transferred onto the substrate using photoresist and photolithography, where the substrate is soaked into a chemical enchant that can selectively etch the metal film and the photoresist at different etch rates or can use ion-milling or a reactive ion etcher for etching the metal. The substrate with a metal mask is placed into the reactive ion etcher with a different gas such as oxygen or CF4 to etch away the substrate. The photoresist and metal mask are removed after the substrate is patterned.

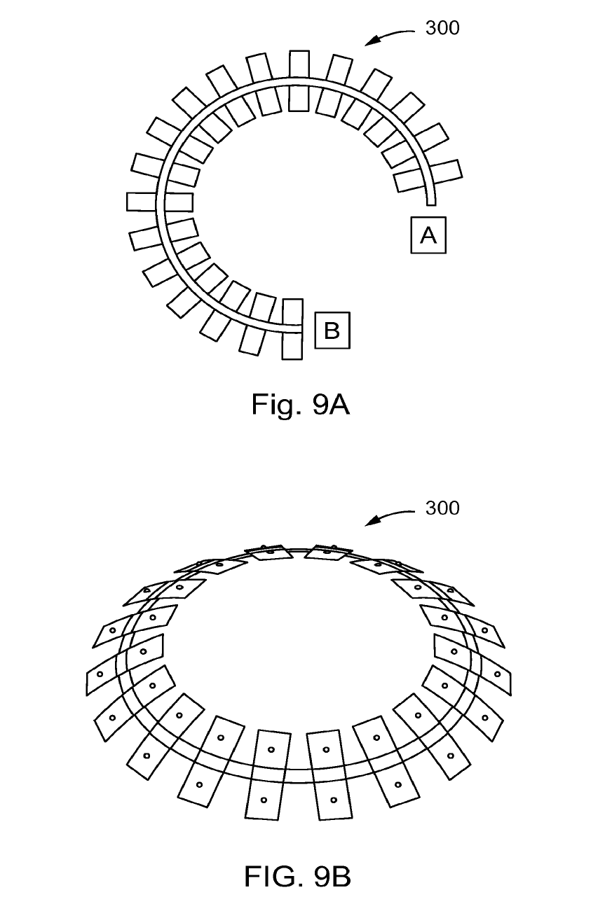

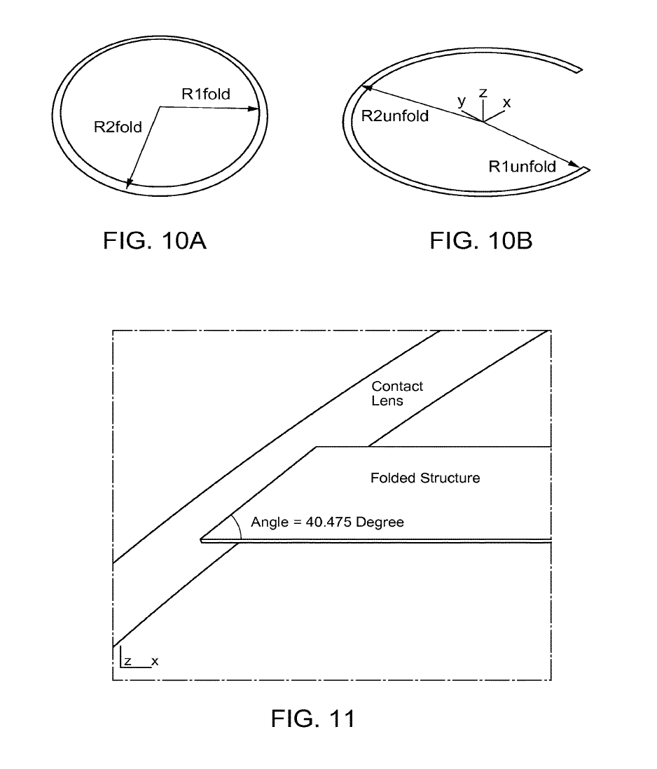

Whether using molding or etching, in one approach, the elastic electronic assembly 300 can first assume an unfolded structure having end points A and B (See FIG. 9A). All existing semiconductors and components can be used during fabrication, and planar photolithography and/or laser cutting can further increase cost savings during manufacture. Next, the unfolded structure is mechanically joined at points A and B through soldering, epoxy, welding, or a mechanical snap (FIG. 9B). The resulting structure can thus assume a convex shape, with a layout conforming to the contours of a contact lens. Generally, the radius of the unfolded structure is larger than that of the folded structure, R(unfolded)=1.312*R(folded) (See FIGS. 10A and B). This is assuming the angle of the folded structure is 40.475 degrees as shown in FIG. 11. Here, the circumference will remain the same. It is to be recognized that as presented above, however, that various other open and closed shapes are contemplated including polygonal and other curved but non-circular profiles.

Once the desired interconnection member patterns are created, the circuit can be completed. Notably, these patterns operate as electrical interconnections and the electrical components are inserted between these electrical interconnections. Components can include one or more of integrated circuits, piezoelectric components, resistors, capacitors, LEDs, amplifiers, transistors, antennas, sensors and other electronic chips or components. Furthermore, the interconnecting members also may include first and third insulating layers and one or more conductive layers.

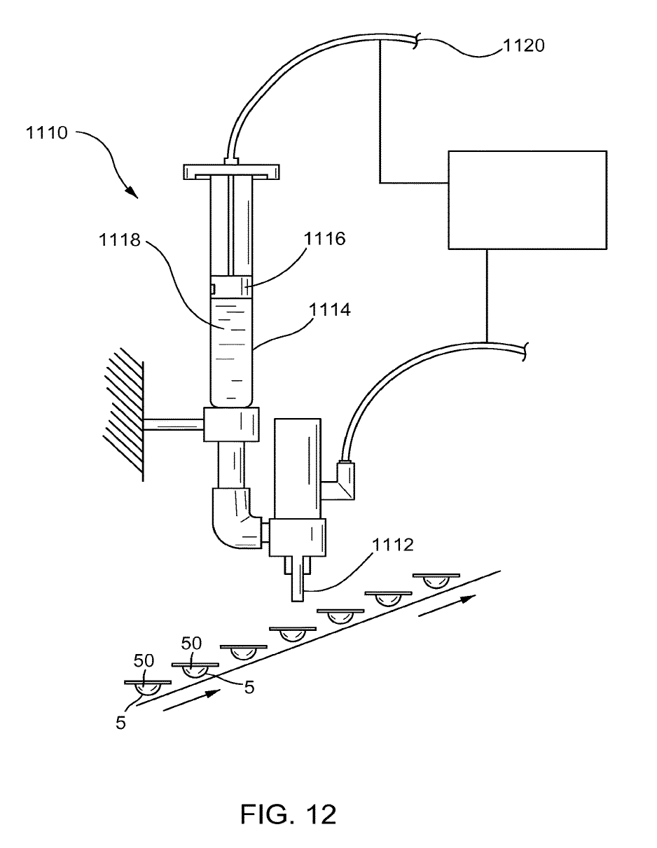

The completed electronic circuit is then placed directly onto a contact lens mold member, preferably the female mold member, or first (anterior) contact lens mold member. The placement can occur robotically and be coupled with a means of centering the assembly and structure or a means of controlling the depth of the assembly during the filling of the mold with a lens precursor material (See FIG. 12), which can be a polymerizable hydrogel or silicone hydrogel lens precursor composition.

In one approach to manufacture, prior or subsequent to precise placement of the electronic circuit on the concave surface of the female mold half 5, the lens precursor composition is placed on the concave surface of the first mold section (See FIGS. 1-1A).

The composition can be placed on the concave surface using any conventional technique or device. However, in certain embodiments, the composition is placed on the concave surface using an automated dispensing apparatus, as shown in FIG. 12. In one approach, the automated dispensing apparatus 1110 comprises a dispensing tip 1112 and a electronic circuit is “sandwiched” between the anterior and posterior surfaces of the contact lens after polymerization.

The first and second mold sections 3, 5 of the mold assembly can be held together using a variety of techniques. For example, the mold sections can be held together by pressure applied to opposing plates contacting opposite sides of the mold assembly. Or, the mold sections can be held together by an interference fit between the first mold section and the second mold section. Or, the mold sections can be welded together.

The lens precursor composition can then be polymerized. The polymerization or curing of the lens precursor composition is effective to form a hydrogel or silicone hydrogel contact lens. In the illustrated embodiment, the polymerizing comprises exposing the lens precursor composition to ultraviolet radiation, heat, or combinations thereof. The polymerizing may comprise moving the contact lens, or a plurality of contact lenses, through a curing system, (not shown) which comprises a plurality of ultraviolet lamps that provide a substantially uniform and substantially constant exposure of the lens precursor composition to the ultraviolet radiation. In certain approaches, the polymerizing involves exposing the lens precursor composition to an intensity of ultraviolet radiation less than about 1000 μW/cm2. The polymerizable lens precursor composition is thus cured to form a pre-extracted polymerized contact lens product.

The contact lens mold is then demolded, where the two mold members are separated. The pre-extracted polymerized contact lens product is next separated from the contact lens mold members, or delensed. After delensing, the pre-extracted contact lens product is washed to remove unreacted monomers, diluents, and the like.

After washing, the extracted polymerized contact lens product can be hydrated with water or an aqueous solution to form a hydrated hydrogel or silicone hydrogel contact lens. The method may involve placing the contact lens in an aqueous medium to hydrate the lens. For example, the contact lens or lenses may be placed in deionized water and the like to saturate the lens or swell the lens, such swelling occurring in multi-dimensions.

Alternatively, as stated above, washing can be accomplished by exposing the polymerized lens to water or aqueous solution free of organic solvents, which thus, also results in the lens swelling in size in multiple dimension. In either approach, the elastic electronic circuit 50 reacts to the swelling without causing undesirable, adverse or surprising distortion to the lens, and without causing voids to be formed within the polymer of the lens near or adjacent to the electronic circuit. That is, the multi-dimensional flexing interconnecting members of the elastic circuit expand and contract in cooperation with and responsive to the changing dimensions and orientation of the lens structure.

Accordingly, the pre-extracted polymerized contact lens products and the washed polymerized contact lens products are water swellable products or elements, and the hydrated contact lens is a product or element swollen with water. Thus, a silicone hydrogel contact lens can be understood to be a fully hydrated silicone hydrogel contact lens, a partially hydrated silicone hydrogel contact lens, or a dehydrated silicone hydrogel contact lens. A dehydrated silicone hydrogel contact lens refers to a contact lens that has undergone a hydration procedure and has subsequently been dehydrated to remove water from the lens.

The methods of manufacturing the present contact lenses can also include a step of packaging the contact lens. For example, the contact lens can be placed in a blister pack or other suitable container that includes a volume of a liquid, such as a saline solution, including buffered saline solutions. The stretchable polymer will swell and shrink during manufacture and use, and will generally have curved or hemispherical shape. The electronic circuit attached to or incorporated within the swellable and stretchable polymer therefore adapts to provide elasticity in multiple dimensions.

While the above description contains specific details regarding certain elements, sizes, and other teachings, it is understood that embodiments of the invention or any combination of them may be practiced without these specific details. Specifically, although shapes and orientations are designated in the above embodiments, any shape and orientation may be used so long as it adequately performs as intended. These details should not be construed as limitations on the scope of any embodiment, but merely as exemplifications of the presently preferred embodiments. In other instances, well known structures, elements, and techniques have not been shown to clearly explain the details of the invention.

Moreover, while this invention has been described with respect to various specific examples and embodiments, it is to be understood that the invention is not limited thereto and that it can be variously practiced within the scope of the following claims.

What is claimed is:

1. A swellable medical device, comprising:
a substrate having a first size, and formed of a material that allows the substrate to swell to a second size that is different than the first size; and
an elastic electronic circuit provided on or in the substrate, the elastic electronic circuit comprising a first pattern that allows the elastic electronic circuit to stretch as the substrate swells from the first size to the second size.

2. The medical device of claim 1, wherein the first pattern of the elastic electronic circuit has a horseshoe shape having a turning degree from 0 degrees to 45 degrees.

3. The medical device of claim 1, wherein the substrate material is a hydrogel polymer.

4. The medical device of claim 1, wherein the substrate material is a silicone hydrogel polymer.

5. The medical device of claim 1, wherein the substrate has a semispheroidal shape having an apex region, and the elastic electronic circuit circumscribes the apex region.

6. The medical device of claim 1, wherein the medical device is an ophthalmic lens.

7. The medical device of claim 1, wherein the medical device is an contact lens.

8. A method of manufacturing a swellable medical device, comprising:
forming a material into a substrate having a first size and that can swell to a second size that is different than the first size; and
providing an elastic electronic circuit on or in the substrate, wherein the elastic electronic circuit comprises a first pattern that allows the elastic electronic circuit to stretch as the substrate swells from the first size to the second size.

9. The method of claim 8, wherein the first pattern of the elastic electronic circuit has a horseshoe shape having a turning degree from 0 degrees to 45 degrees.

10. The method of claim 8, wherein the substrate material is a hydrogel polymer.

11. The method of claim 8, wherein the substrate material is a silicone hydrogel polymer.

12. The method of claim 8, wherein the substrate has a semispheroidal shape having an apex region, and the elastic electronic circuit circumscribes the apex region.

13. The method of claim 8, wherein the medical device is an ophthalmic lens.

14. The method of claim 8, wherein the medical device is a contact lens.

15. A flexible medical device, comprising:
a substrate having a first size, and formed of a material that allows the substrate to change to a second size that is different than the first size; and
an elastic electronic circuit provided on or in the substrate, the elastic electronic circuit comprising a first pattern that allows the elastic electronic circuit to stretch as the substrate changes from the first size to the second size;
wherein the substrate is not distorted by the elastic electronic circuit upon the changing of size of the substrate.

16. The medical device of claim 15, wherein the substrate is flexible and is not distorted by the elastic electronic circuit upon flexing of the substrate.

17. The medical device of claim 15, the elastic electronic circuit further comprising an interconnecting member attached to one or more electronic components.

18. The medical device of claim 17, wherein the interconnecting member includes a first curved or angled structure and a second curved or angled structure embedded in the first curved or angled structure.

19. The medical device of claim 18, wherein the interconnecting member includes a third curved or angled structure embedded in the second curved or angled structure.

20. The medical device of claim 15, wherein the medical device is a contact lens and the elastic electronic circuit further comprises an interconnecting member attached to one or more electronic components, wherein the interconnecting member is non-planar and the electronic components enhance, modify or extend lens function.

21. The medical device of claim 1, wherein said first pattern further comprises a second pattern embedded within said first pattern.

22. The medical device of claim 21, wherein said second pattern further comprises a third pattern embedded within said second pattern.
